(19) United States
(12) Patent Application Publication
(10) Pub. No.: US 2022/0376404 A1
(43) Pub. Date: Nov. 24, 2022

(54) MULTIBAND ANTENNA

(71) Applicant: JAPAN AVIATION ELECTRONICS INDUSTRY, LIMITED, Tokyo (JP)

(72) Inventors: Hiroshi TOYAO, Tokyo (JP); Kenta TSUCHIYA, Tokyo (JP)

(73) Assignee: JAPAN AVIATION ELECTRONICS INDUSTRY, LIMITED, Tokyo (JP)

(21) Appl. No.: 17/713,492

(22) Filed: Apr. 5, 2022

(30) Foreign Application Priority Data
May 19, 2021 (JP) 2021-084565

(51) Int. Cl. H01Q 21/06; H01Q 5/50

(52) U.S. Cl. CPC H01Q 21/064; H01Q 5/50

(57) ABSTRACT

A multiband antenna has a conductor main portion, a first ground terminal and a second ground terminal. The conductor main portion is long in a first direction and extends in a horizontal plane defined by the first direction and a second direction. The conductor main portion has a first long edge and a second long edge at both ends thereof in the second direction, respectively. The conductor main portion is formed with a slot and an opening portion. The slot is long in the first direction. The opening portion is provided in the first long edge and connects the slot with an outside of the conductor main portion. The first ground terminal and the second ground terminal extend from the second long edge. The first ground terminal and the second ground terminal are connected to a host conductor when the multiband antenna is used.

### CROSS REFERENCE TO RELATED APPLICATIONS

This application is based on and claims priority under 35 U.S.C. § 119 to Japanese Patent Application No. JP2021-084565 filed May 19, 2021, the contents of which are incorporated herein in their entirety by reference.

### BACKGROUND OF THE INVENTION

This invention relates to a multiband antenna, particularly to a multiband antenna provided with a conductor main portion formed with a slot.

JP 2012-85262 A (Patent Document 1) discloses an example of an antenna device provided with a conductive plate formed with a slot.

As shown in FIG. 18, an antenna device 90 disclosed in Patent Document 1 is provided with a conductive plate 910 provided on one surface of a dielectric substrate (not shown). The conductive plate 910 is formed with two slots 920 and 930. The slots 920 and 930 have open ends 922 and 932, respectively. The slots 920 and 930 are arranged so that the open ends 922 and 932 face each other. The open ends 922 and 932 are contiguous to an opening portion 940 which opens at an edge of the conductive plate 910.

The antenna device 90 further has a stub 950. The stub 950 is formed on the other surface of the dielectric substrate (not shown). One end of the stub 950 is connected to the conductive plate 910 through a via 960. The stub 950 extends so as to intersect with the slot 920 when viewed in plane.

### SUMMARY OF THE INVENTION

The antenna device 90 of Patent Document 1 uses the conductive plate 910 formed on the surface of the dielectric substrate. Accordingly, the antenna device 90 has a problem that it is difficult to reduce a size thereof.

It is an object of the present invention to provide a multiband antenna which can reduce a size thereof without deterioration of antenna characteristics.

One aspect of the present invention provides a multiband antenna which is connected to a host conductor when used. The multiband antenna has a conductor main portion, a first ground terminal and a second ground terminal. The conductor main portion is long in a first direction and extends in a horizontal plane which is defined by the first direction and a second direction perpendicular to the first direction. The first ground terminal and the second ground terminal are connected to the host conductor when the multiband antenna is used. The conductor main portion has a first long edge and a second long edge at both ends thereof in the second direction, respectively. The conductor main portion is formed with a slot and an opening portion. The slot is long in the first direction. The opening portion is provided in the first long edge and connects the slot with an outside of the conductor main portion. The first ground terminal and the second ground terminal extend from the second long edge.

An appreciation of the objectives of the present invention and a more complete understanding of its structure may be had by studying the following description of the preferred embodiment and by referring to the accompanying drawings.

The multiband antenna of one aspect of the present invention has the first ground terminal and the second ground terminal both of which extend from the second long edge of the conductor main portion. With this structure, an external conductor can be used as the host conductor, and the multiband antenna itself can be downsized. In addition, by appropriately setting positions of the first ground terminal and the second ground terminal, a high radiation efficiency can be achieved.

### BRIEF DESCRIPTION OF THE DRAWINGS

FIG. 1 is a plan view showing a multiband antenna according to an embodiment of the present invention.

FIG. 2 is a plan view showing a first modification of the multiband antenna of FIG. 1.

FIG. 3 is a plan view showing a second modification of the multiband antenna of FIG. 1.

FIG. 4 is a perspective view showing a third modification of the multiband antenna of FIG. 1.

FIG. 5 is a perspective view showing a fourth modification of the multiband antenna of FIG. 1.

FIG. 6 is a perspective view showing a fifth modification of the multiband antenna of FIG. 1.

FIG. 7 is a perspective view showing a sixth modification of the multiband antenna of FIG. 1.

FIG. 8 is a perspective view showing a seventh modification of the multiband antenna of FIG. 1.

FIG. 9 is a perspective view showing an eighth modification of the multiband antenna of FIG. 1.

FIG. 10 is a perspective view showing a ninth modification of the multiband antenna of FIG. 1.

FIG. 11 is a perspective view showing a tenth modification of the multiband antenna of FIG. 1.

FIG. 12 is a perspective view showing an eleventh modification of the multiband antenna of FIG. 1.

FIG. 13 is a perspective view showing a twelfth modification of the multiband antenna of FIG. 1.

FIG. 14 is a perspective view showing a thirteenth modification of the multiband antenna of FIG. 1.

FIG. 15 is a perspective view showing a fourteenth modification of the multiband antenna of FIG. 1.

FIG. 16 is a perspective view showing a fifteenth modification of the multiband antenna of FIG. 1.

FIG. 17 is a perspective view showing a modification of the multiband antenna of FIG. 8.

FIG. 18 is a plan view showing an antenna device disclosed in Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

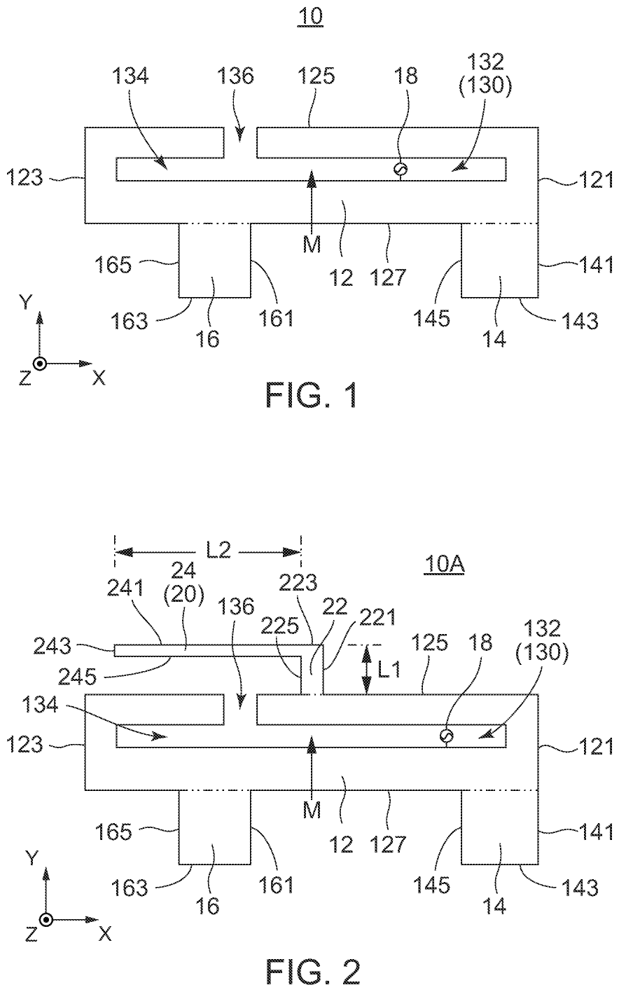

Referring to FIG. 1, a multiband antenna 10 according to an embodiment of the present invention has a conductor main portion 12, a first ground terminal 14 and a second ground terminal 16.

As shown in FIG. 1, the conductor main portion 12 extends in a horizontal plane defined by a first direction and a second direction which are perpendicular to each other. In the present embodiment, the first direction is an X-direction, and the second direction is a Y-direction. In detail, the conductor main portion 12 has a rectangular shape long in the first direction. The conductor main portion 12 has a first short edge 121 and a second short edge 123 at both ends thereof in the first direction, respectively, and has a first long edge 125 and a second long edge 127 at both ends thereof in the second direction, respectively. However, the present invention is not limited thereto. Each of the first short edge 121, the second short edge 123, the first long edge 125 and the second long edge 127 may not be linear.

As shown in FIG. 1, the conductor main portion 12 is formed with a slot 130 and an opening portion 136. The slot 130 has a rectangular shape long in the first direction. The slot 130 is apart from each of the first short edge 121, the second short edge 123, the first long edge 125 and the second long edge 127. In other words, the slot 130 does not open in each of the first short edge 121, the second short edge 123, the first long edge 125 and the second long edge 127. In the present embodiment, the middle M of the slot 130 in the first direction coincides with the middle of the conductor main portion 12 in the first direction. Moreover, in the second direction, the slot 130 is nearer to the first long edge 125 than to the second long edge 127. However, the present invention is not limited thereto. A position of the slot 130 with respect to the conductor main portion 12 may be freely set according to the desired characteristic.

As shown in FIG. 1, the opening portion 136 is provided in the first long edge 125 of the conductor main portion 12. In detail, the opening portion 136 connects the slot 130 with the outside of the conductor main portion 12 in the second direction. In other words, the opening portion 136 extends from the slot 130 in a positive Y-direction and opens in the first long edge 125 of the conductor main portion 12.

As understood from FIG. 1, the slot 130 has a first slot 132 and a second slot 134 which are divided by the opening portion 136. The first slot 132 and the second slot 134 are arranged in the first direction. In detail, the first slot 132 is nearer to the first short edge 121 than to the second short edge 123 in the first direction, and the second slot 134 is nearer to the second short edge 123 than to the first short edge 121 in the first direction.

As understood from FIG. 1, in the first direction, a size of the first slot 132 and a size of the second slot 134 are different from each other. In detail, in the first direction, the size of the first slot 132 is larger than the size of the second slot 134. In the first direction, each of the size of the first slot 132 and the size of the second slot 134 is decided according to a desired resonance frequency thereof. In the present embodiment, a first resonance frequency that the first slot 132 has and a second resonance frequency that the second slot 134 has are different from each other.

As shown in FIG. 1, the first ground terminal 14 and the second ground terminal 16 extend from the second long edge 127 of the conductor main portion 12. In the present embodiment, the first ground terminal 14 and the second ground terminal 16 extend in a negative Y-direction along the second direction.

As shown in FIG. 1, in the present embodiment, each of the first ground terminal 14 and the second ground terminal 16 has an approximately square shape. In addition, the first ground terminal 14 has a first edge 141, a second edge 143 and a third edge 145, and the second ground terminal 16 has a first edge 161, a second edge 163 and a third edge 165. However, the present invention is not limited thereto.

Each of the first ground terminal 14 and the second ground terminal 16 may have a rectangular shape long in the first direction or the second direction. Moreover, the first ground terminal 14 and the second ground terminal 16 may be different from each other in shape. Furthermore, each of the second edge 143 of the first ground terminal 14 and the second edge 163 of the second ground terminal 16 may be formed with one or more recess portions or cut portions.

As understood from FIG. 1, when used, feeding for the multiband antenna 10 is carried out so as to extend over the first slot 132. For that purpose, the multiband antenna 10 is provided with a feeding point 18 at an edge of the first slot 132. In the first direction, the feeding point 18 is located on a side of the first short edge 121 when viewed from the opening portion 136.

As shown in FIG. 1, in the first direction, the first ground terminal 14 is located on the side of the first short edge 121 at least in part when viewed from the feeding point 18. In the present embodiment, the whole of the first ground terminal 14 is located on the side of the first short edge 121 when viewed from the feeding point 18. However, the present invention is not limited thereto. The first ground terminal 14 may be located on a side of the second short edge 123 in part when viewed from the feeding point 18.

As shown in FIG. 1, in the present embodiment, the first ground terminal 14 extends in the negative Y-direction along the second direction so as to be contiguous to the first short edge 121. In other words, in the present embodiment, a position of the first edge 141 of the first ground terminal 14 in the first direction coincides with a position of the first short edge 121. However, the present invention is not limited thereto. In the present invention, the first edge 141 of the first ground terminal 14 may be apart from the first short edge 121 toward the second short edge 123. And yet, radiation efficiency is higher when the position of the first edge 141 of the first ground terminal 14 coincides with the position of the first short edge 121 than when it is not. Accordingly, it is preferable that the first ground terminal 14 extends at least in part so as to be contiguous to the first short edge 121.

As shown in FIG. 1, in the present embodiment, the second ground terminal 16 is located on the side of the second short edge 123 when viewed from the feeding point 18. In detail, the second ground terminal 16 is located on the side of the second short edge 123 in part when viewed from the opening portion 136. However, the present invention is not limited thereto. The second ground terminal 16 may be located on the side of the second short edge 123 in whole when viewed from the opening portion 136.

The multiband antenna 10 of FIG. 1 may be formed by, for example, punching a metal plate (a conductor plate). Alternatively, the conductor main portion 12 may be formed of a metal plate while the first ground terminal 14 and the second ground terminal 16 may be formed of other members, such as copper tapes. Or, the multiband antenna 10 may be formed by patterning a conductive layer (not shown) formed on a dielectric substrate (not shown). At any rate, the multiband antenna 10 is connected to a host conductor (80, see FIGS. 6 to 8) when used. In detail, the first ground terminal 14 and the second ground terminal 16 are connected to the host conductor when the multiband antenna 10 is used. In a case where at least the conductor main portion 12 of the multiband antenna 10 is made of a metal plate, the host conductor may be a conductor layer formed on a substrate on which the multiband antenna 10 is mounted. In a case where the multiband antenna 10 is made of a conductive layer included in a multilayer substrate, the host conductor may be made of the conductive layer of which the multiband antenna 10 is made or may be made of another conductive layer, such as a ground plane, of the multilayer substrate. However, the present invention is not limited thereto. The host conductor may be a metal case of a communication device including the multiband antenna 10 or a metal plate for heat radiation.

According to the present embodiment, the multiband antenna 10 uses an external conductor as the host conductor (80, see FIGS. 6 to 8), so that the antenna itself can be reduced in size. Moreover, by appropriately arranging the first ground terminal 14 and the second ground terminal 16, high radiation efficiency can be realized.

Although the description about the embodiment of the present invention is made above, the multiband antenna 10 according to the present embodiment may be modified as follows. In the following description, the same or the similar components are represented by the same or the similar reference signs and the description thereof are omitted.

### First Modification

Referring to FIG. 2, a multiband antenna 10A according to a first modification is provided with a radiation element 20 in addition to the structure of the multiband antenna 10.

As shown in FIG. 2, in the present modification, the radiation element 20 has a first part 22 and a second part 24. The first part 22 of the radiation element 20 has a rectangular shape long in the second direction. Moreover, the second part 24 of the radiation element 20 has a rectangular shape long in the first direction.

As shown in FIG. 2, the first part 22 of the radiation element 20 extends from the first long edge 125 of the conductor main portion 12 so as to go away from the slot 130. Moreover, the second part 24 of the radiation element 20 extends from the first part 22 in a negative X-direction along the first direction.

As understood from FIG. 2, the first part 22 of the radiation element 20 has a first length L1 in the second direction, and the second part 24 of the radiation element 20 has a second length L2 in the first direction. In the present modification, the second length L2 is set to be longer than the first length L1. The first length L1 and the second length L2 are decided on the basis of a third resonance frequency that the radiation element 20 should have.

As shown in FIG. 2, the first part 22 of the radiation element 20 is nearer to the first slot 132 than to the second slot 134. Moreover, the first part 22, at least in part, is nearer to the opening portion 136 than to the middle M of the slot 130 in the first direction. In detail, the first part 22 has a first edge 221, a second edge 223 and a third edge 225. And, the third edge 225 of the first part 22 is located between the opening portion 136 and the middle M of the slot 130 in the first direction. In the present modification, a position of the first edge 221 of the first part 22 in the first direction is nearer to the middle M of the slot 130 than to the first short edge 121.

As shown in FIG. 2, the second part 24 of the radiation element 20 has a first edge 241, a second edge 243 and a third edge 245. In the present modification, a position of the first edge 241 of the second part 24 in the second direction coincides with a position of the second edge 223 of the first part 22. Moreover, in the present modification, the second part 24 is away from the first long edge 125 of the conductor main portion 12. In other words, in the second direction, a size of the second part 24 is smaller than the first length L1 of the first part 22. In the first direction, a position of the second edge 243 of the second part 24 is between the second short edge 123 of the conductor main portion 12 and the opening portion 136.

### Second Modification

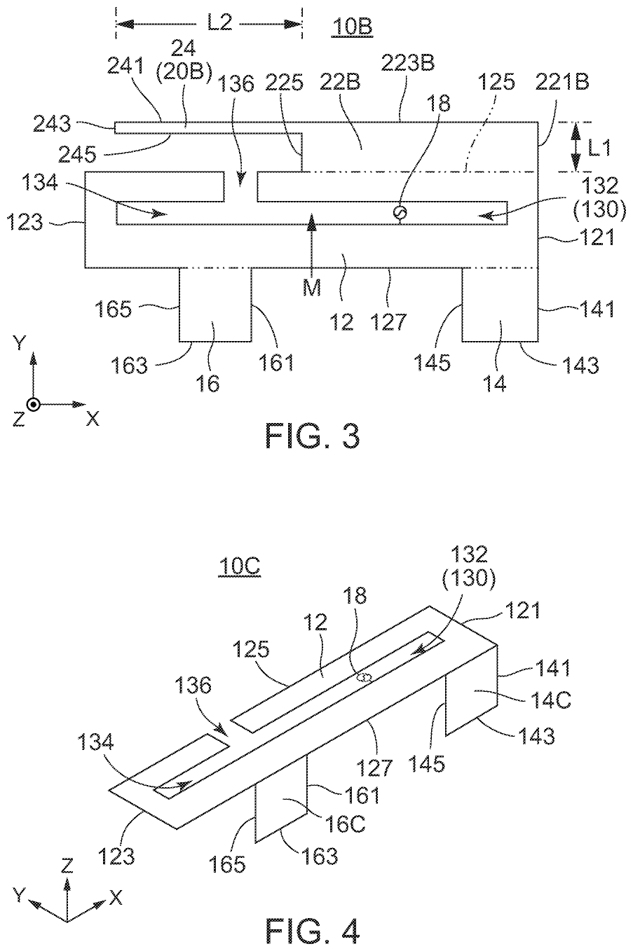

Referring to FIG. 3, a multiband antenna 10B according to a second modification is provided with a radiation element 20B having a shape different from that of the radiation element 20 of the multiband antenna 10A.

As shown in FIG. 3, the radiation element 20B has a first part 22B and a second part 24. In the present modification, the first part 22B has a rectangular shape long in the first direction. In the first direction, a position of a first edge 221 B of the first part 22B coincides with a position of the first short edge 121 of the conductor main portion 12.

Each of the multiband antennas 10, 10A and 10B is formed two-dimensionally. However, the present invention is not limited thereto. The multiband antenna of the present invention may be formed three-dimensionally as in each of third to fifteenth modifications mentioned below. Each of the three-dimensional multiband antennas can be formed by punching and bending a single metal plate, for example. The present invention is not limited thereto. Each of the multiband antennas may be formed by combining a plurality of conductive plates. Moreover, if necessary, in order to improve strength, one or more conductive plates may be combined with a support, which is made of insulation resin, for example.

### Third Modification

Referring to FIG. 4, a multiband antenna 10C according to the third modification has a conductor main portion 12, a first ground terminal 14C and second ground terminal 16C similarly to the multiband antenna 10 of FIG. 1.

As shown in FIG. 4, each of the first ground terminal 14C and the second ground terminal 16C has a part extending from the second long edge 127 of the conductor main portion 12 in a direction intersecting with the conductor main portion 12 or with the horizontal plane. In the present modification, each of the first ground terminal 14C and the second ground terminal 16C extends downward along an up-down direction in whole. In the present modification, the up-down direction is a Z-direction. Moreover, a positive Z-direction is directed upward while a negative Z-direction is directed downward.

As analogized from FIGS. 6 to 8, the multiband antenna 10C of FIG. 4 has the parts extending in the direction intersecting with the conductor main portion 12 or the horizontal plane, so that a distance from the conductor main portion 12 to the host conductor 80 can be increased without increasing an occupied area of the multiband antenna 10C when viewed along the up-down direction. Thus, the multiband antenna 10C can be hard to be influenced from the host conductor 80.

### Fourth Modification

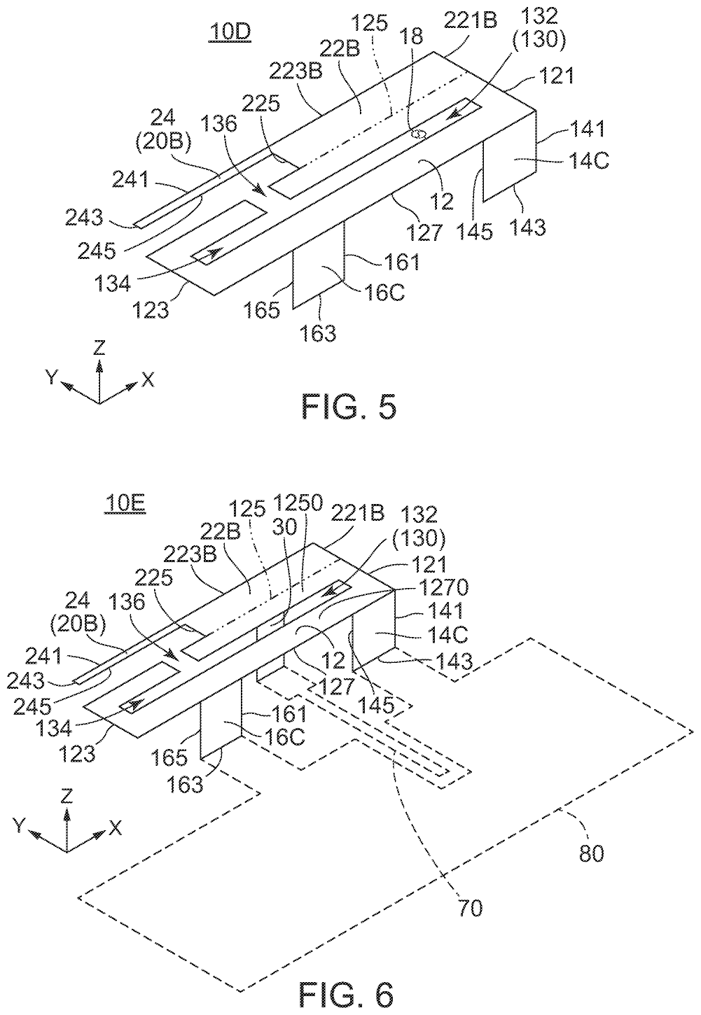

Referring to FIG. 5, a multiband antenna 10D according to the fourth modification is similar to the multiband antenna 10B according to the second modification. However, the multiband antenna 10D is provided with a first ground terminal 14C and a second ground terminal 16C which extend downward similarly to those of the multiband antenna 10C.

Although each of the multiband antennas 10 and 10A to 10D described above is fed to the feeding point 18, the multiband antenna of the present invention may be further provided with a feeding terminal 30 or 30F as in each of fifth to seventh modifications. As described later, the feeding terminal 30 or 30F has a part intersecting with the horizontal plane, so that each of multiband antennas 10E to 10G can be surface-mounted on a circuit board (not shown) which is an object.

### Fifth Modification

Referring to FIG. 6, the multiband antenna 10E according to the fifth modification is further provided with the feeding terminal 30 in addition to the structure of the multiband antenna 10D according to the fourth modification.

As shown in FIG. 6, the feeding terminal 30 has a rectangular shape and is provided to the conductor main portion 12. In detail, the conductor main portion 12 has a facing portion 1250 and a connection portion 1270 which are arranged to interpose the slot 130 therebetween, and the feeding terminal 30 is provided to the facing portion 1250. In more detail, the feeding terminal 30 has a part extending from an inner edge of the first slot 132 defined by the facing portion 1250 in the direction intersecting with the horizontal plane. In the present modification, the feeding terminal 30 extends downward in whole. Here, the facing portion 1250 is a part located between the first long edge 125 of the conductor main portion 12 and the slot 130, and the connection portion 1270 is a part located between the second long edge 127 of the conductor main portion 12 and the slot 130. In the present modification, the feeding terminal 30 is made of the same metal plate as the conductor main portion 12.

As shown in FIG. 6, the feeding terminal 30 is provided on a side of the first short edge 121 in the first direction when viewed from the opening portion 136. Moreover, the first ground terminal 14C is located on the side of the first short edge 121 at least in part when viewed from the feeding terminal 30, and the second ground terminal 16C is located on the side of the second short edge 123 at least in part when viewed from the feeding terminal 30. In the present modification, the whole of the first ground terminal 14C is located on the side of the first short edge 121 when viewed from the feeding terminal 30, and the whole of the second ground terminal 16C is located on the side of the second short edge 123 when viewed from the feeding terminal 30.

As understood from FIG. 6, the feeding terminal 30 is connected to a feeding line 70 formed on an object (not shown) when mounted on the object. Moreover, both of the first ground terminal 14C and the second ground terminal 16C are connected to the host conductor 80. The object is a multilayer substrate, for example. The feeding line 70 and the host conductor 80 are formed of the same conductor layer included in the multilayer substrate or formed of different conductor layers included in the multilayer substrate.

### Sixth Modification

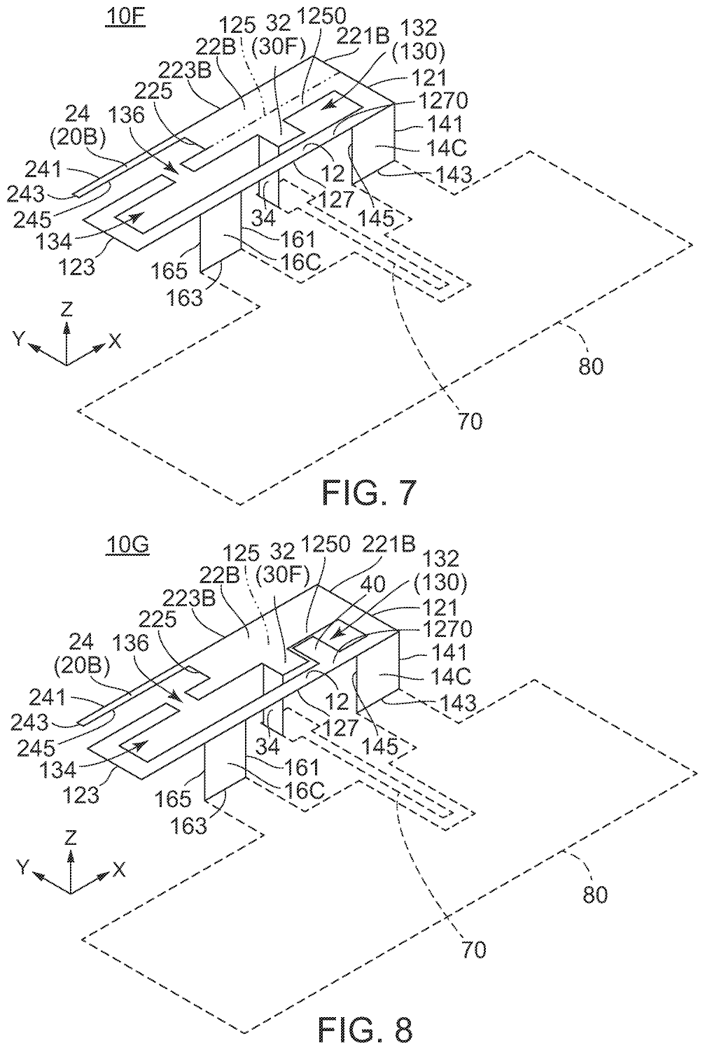

Referring to FIG. 7, the multiband antenna 10F according to the sixth modification has the feeding terminal 30F having a shape different from that of the feeding terminal 30 of the multiband antenna 10E according to the fifth modification.

As shown in FIG. 7, the feeding terminal 30F has a first feeding portion 32 and a second feeding portion 34. The first feeding portion 32 extends from the facing portion 1250 of the conductor main portion 12 in the horizontal plane. The second feeding portion 34 extends, in the direction intersecting with the horizontal plane, from one end of the first feeding portion 32 in the first direction. In the present modification, the first feeding portion 32 extends from the inner edge of the first slot 132 in the negative Y-direction and protrudes in the first slot 132. The second feeding portion 34 extends downward from a negative X-side edge of the first feeding portion 32.

As understood from comparing FIGS. 6 and 7, the feeding terminal 30 of the multiband antenna 10E of FIG. 6 needs to be formed separately from the conductor main portion 12, and then to be connected to the conductor main portion 12. In contrast to this, the feeding terminal 30F of the multiband antenna 10F according to the present modification can be formed by cutting and bending the same metal plate as the conductor main portion 12. Accordingly, the multiband antenna 10F is easy to be manufactured in comparison with the multiband antenna 10E.

### Seventh Modification

Referring to FIG. 8, the multiband antenna 10G according to the seventh modification is further provided with a stub 40 in addition to the structure of the multiband antenna 10F according to the sixth modification.

As shown in FIG. 8, the stub 40 is provided to the conductor main portion 12 to across the slot 130 approximately. In detail, the stub 40 is between the feeding terminal 30F and the first short edge 121 in the first direction. One end of the stub 40 is connected to the connection portion 1270, and the stub 40 extends toward the facing portion 1250. The stub 40 does not reach the facing portion 1250, and the other end of the stub 40 is apart from the facing portion 1250 and faces the facing portion 1250. In the present modification, the stub 40 is formed of the same metal plate as the conductor main portion 12 in conjunction with the feeding terminal 30F. Accordingly, the multiband antenna 10G is easy to be manufactured in comparison with the multiband antenna 10E. However, the present invention is not limited thereto. The stub 40 may be located between the feeding terminal 30F and the second short edge 123 in the first direction. The position of the stub 40 in the first direction is decided on the basis of a desired characteristic.

In each of the multiband antennas 10 and 10A to 10G of FIGS. 1 to 8, the conductor main portion 12 is formed two-dimensionally. However, the present invention is not limited thereto. In the multiband antenna of the present invention, the conductor main portion 12 may be formed three-dimensionally as in each of eighth to twelfth modifications mentioned below.

### Eighth Modification

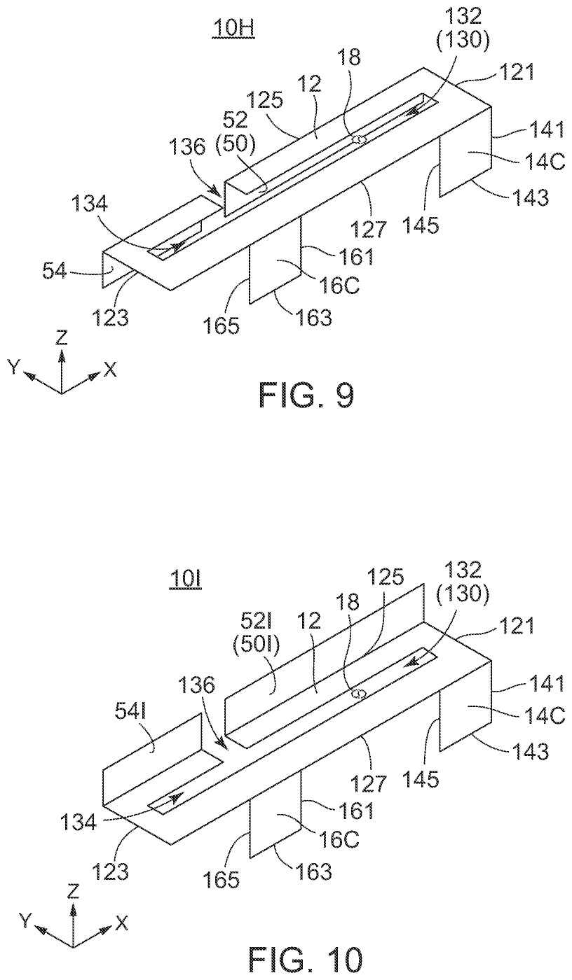

Referring to FIG. 9, a multiband antenna 10H according to the eighth modification has an extension portion 50 in addition to the structure of the multiband antenna 10C according to the third modification.

As shown in FIG. 9, the extension portion 50 has a first extension portion 52 and a second extension portion 54. Each of the first extension portion 52 and the second extension portion 54 has a rectangular shape long in the first direction. The first extension portion 52 and the second extension portion 54 are arranged in the first direction to interpose the opening portion 136 therebetween. Both of the first extension portion 52 and the second extension portion 54 extend from the first long edge 125 of the conductor main portion 12 in the direction intersecting with the horizontal plane. In the present modification, the first extension portion 52 and the second extension portion 54 extend downward. Since the multiband antenna 10H has the extension portion 50, radiation efficiency thereof can be increased without increasing an occupied area thereof when viewed along the up-down direction.

### Ninth Modification

Referring to FIG. 10, a multiband antenna 10I according to the ninth modification has an extension portion 50O different from that of the multiband antenna 10H according to the eighth modification. The extension portion 50O has a first extension portion 52I and a second extension portion 54O. The first extension portion 52O and the second extension portion 54O extend upward from the first long edge 125 of the conductor main portion 12.

### Tenth Modification

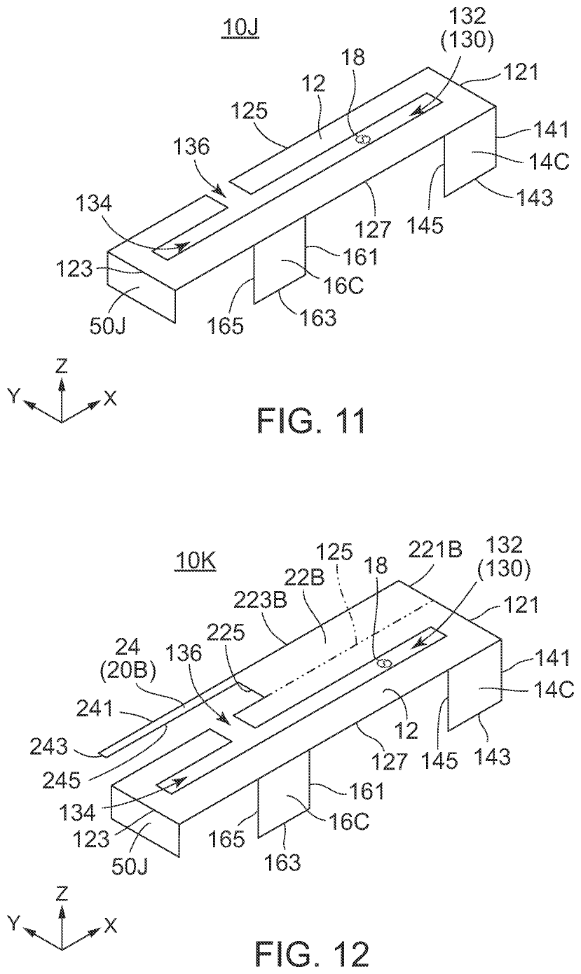

Referring to FIG. 11, a multiband antenna 10J according to the tenth modification has an extension portion 50J different from that of the multiband antenna 10H according to the fifth modification. The extension portion 50J has a rectangular shape long in the second direction and extends from the second short edge 123 of the conductor main portion 12 in the direction intersecting with the horizontal plane. In the present modification, the extension portion 50J extends downward. However, the present invention is not limited thereto. The extension portion 50J may extend upward.

### Eleventh Modification

Referring to FIG. 12, a multiband antenna 10K according to the eleventh modification has an extension portion 50J in addition to the structure of the multiband antenna 10D according to the fourth modification. However, the present invention is not limited thereto. The extension portion 50J may extend upward.

### Twelfth Modification

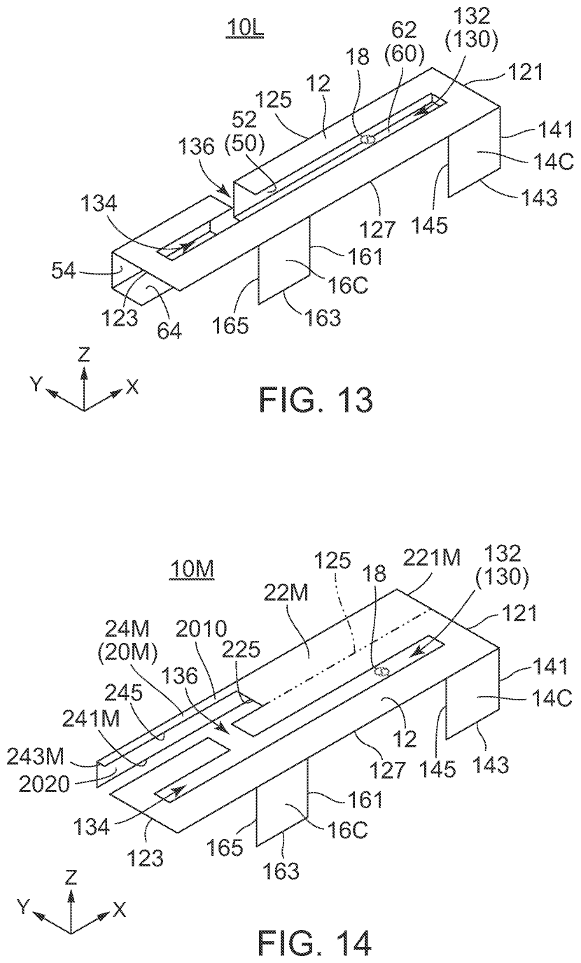

Referring to FIG. 13, a multiband antenna 10L according to the twelfth modification further has an additional extension portion 60 in addition to the structure of the multiband antenna 10H according to the eighth modification. The additional extension portion 60 has a first additional extension portion 62 and a second additional extension portion 64. Each of the first additional extension portion 62 and the second additional extension portion 64 has a rectangular shape long in the first direction. The first additional extension portion 62 and the second additional extension portion 64 extend from a lower edge of the first extension portion 52 and a lower edge of the second extension portion 54, respectively, in the negative Y-direction along the second direction. Since the multiband antenna 10L has the additional extension portion 60, the radiation efficiency thereof can be increased without increasing an occupied area thereof when viewed along the up-down direction.

In each of the multiband antennas 10D to 10G according to the fourth to the seventh modifications, the radiation element 20 is formed two-dimensionally. However, the present invention is not limited thereto. In the multiband antenna of the present invention, the radiation element 20 may be formed three-dimensionally as in each of thirteenth to fifteenth modifications mentioned below. If so, radiation efficiency of the multiband antenna can be increased without increasing an occupied area of the antenna when viewed along the up-down direction.

### Thirteenth Modification

Referring to FIG. 14, a multiband antenna 10M according to the thirteenth modification has a radiation element 20M different, in shape, from the radiation element 20 of the multiband antenna 10D according to the fifth modification.

As shown in FIG. 14, the radiation element 20M is bent along the second direction and thereby has a first radiation portion 2010 and a second radiation portion 2020. The first radiation portion 2010 has the same shape as the radiation element 20 in the multiband antenna 10D. The second radiation portion 2020 extends from an edge of the first radiation portion 2010 in the direction intersecting with the horizontal plane. In the present modification, the second radiation portion 2020 extends downward.

### Fourteenth Modification

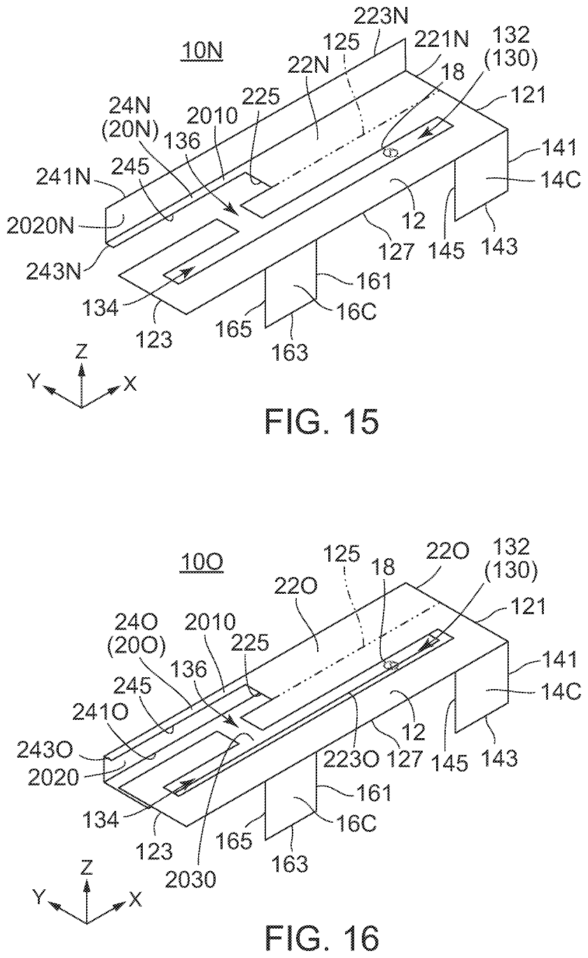

Referring to FIG. 15, a multiband antenna 10N according to the fourteenth modification has a radiation element 20N different, in shape, from the radiation element 20M of the multiband antenna 10M according to the thirteenth modification.

As shown in FIG. 15, the radiation element 20N is bent along the second direction and thereby has a first radiation portion 2010 and a second radiation portion 2020N. The first radiation portion 2010 has the same shape as the radiation element 20 in the multiband antenna 10D. The second radiation portion 2020N extends upward from an edge of the first radiation portion 2010 in the second direction.

### Fifteenth Modification

Referring to FIG. 16, a multiband antenna 10O according to the fifteen modification has a radiation element 20O different, in shape, from the radiation element 20M of the multiband antenna 10M according to the thirteenth modification. The radiation element 20O further has a third radiation portion 2030 in addition to the first radiation portion 201 and the second radiation portion 2020.

As shown in FIG. 16, the third radiation portion 2030 extends from a lower edge of the second radiation portion 2020 in a direction intersecting with the second radiation portion 2020. In the present modification, the third radiation portion 2030 extends in the negative Y-direction along the second direction. Since the multiband antenna 10O has the third radiation portion 2030, radiation efficiency of the radiation element 20O can be further increased.

Although the specific explanation about the present invention is made above with reference to the embodiments, the present invention is not limited thereto but susceptible of various modifications and alternative forms without departing from the spirit of the invention. For example, the feeding terminal 30 or 30F is applicable to each of the multiband antennas 10C and 10H to 10O of the third and the eighth to the fifteenth modifications. Similarly, the stub 40 is applicable to each of the multiband antennas 10C and 10H to 10O of the third and the eighth to the fifteenth modifications.

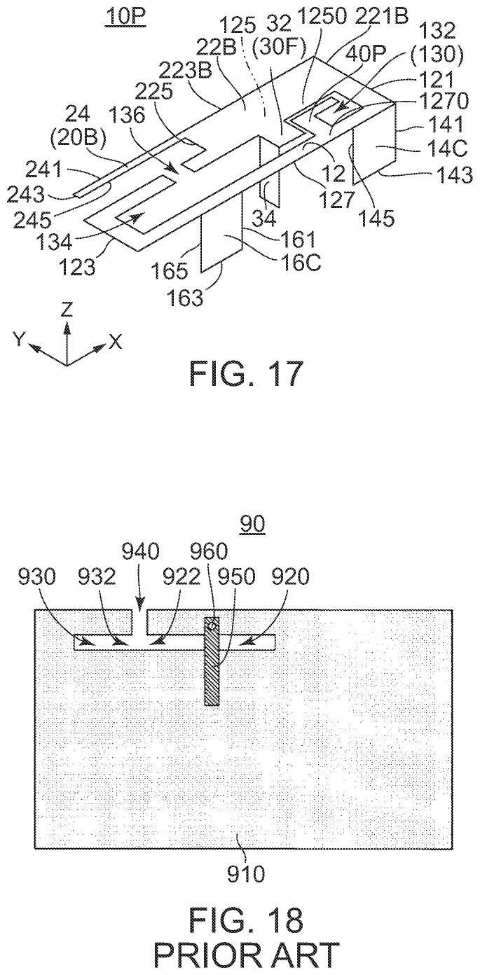

Moreover, although the stub 40 has the rectangular shape in the seventh modification, the present invention is not limited thereto. For example, as in a multiband antenna 10P shown in FIG. 17, a stub 40P may have an L-shape. In detail, the stub 40P extends from the connection portion 1270 in the positive Y-direction along the second direction and further extends in the positive X-direction along the first direction. In the second direction, one end of the stub 40P is connected to the connection portion 1270 while the other end of the stub 40P is apart from and faces the facing portion 1250. Since the stub 40P has the L-shape, an electric length of the stub 40P can be set without being limited by a size of the slot 130 in the second direction.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A multiband antenna which is connected to a host conductor when used, wherein:
the multiband antenna has a conductor main portion, a first ground terminal and a second ground terminal;
the conductor main portion is long in a first direction and extends in a horizontal plane which is defined by the first direction and a second direction perpendicular to the first direction;
the first ground terminal and the second ground terminal are connected to the host conductor when the multiband antenna is used;
the conductor main portion has a first long edge and a second long edge at both ends thereof in the second direction, respectively;
the conductor main portion is formed with a slot and an opening portion;
the slot is long in the first direction;
the opening portion is provided in the first long edge and connects the slot with an outside of the conductor main portion; and
the first ground terminal and the second ground terminal extend from the second long edge.

2. The multiband antenna as recited in claim 1, wherein:
the multiband antenna further has a feeding terminal;
the conductor main portion has a first short edge and a second short edge at both ends thereof in the first direction, respectively;
the slot includes a first slot and a second slot which are arranged in the first direction;
the first slot is nearer to the first short edge than to the second short edge in the first direction;
the second slot is nearer to the second short edge than to the first short edge in the first direction;
the feeding terminal is provided on a side of the first short edge in the first direction when viewed from the opening portion;
the first ground terminal is located on the side of the first short edge at least in part when viewed from the feeding terminal; and
the second ground terminal is located on a side of the second short edge at least in part when viewed from the feeding terminal.

3. The multiband antenna as recited in claim 2, wherein the first ground terminal extends so as to be contiguous to the first short edge at least in part.

4. The multiband antenna as recited in claim 2, wherein each of the first ground terminal and the second ground terminal has a part extending in a direction intersecting with the horizontal surface.

5. The multiband antenna as recited in claim 4, wherein the feeding terminal has a part extending in a direction intersecting with the horizontal direction.

6. The multiband antenna as recited in claim 5, wherein:
at least the conductor main portion and the feeding terminal are formed of a metal plate;
the feeding terminal has a first feeding portion and a second feeding portion;
the first feeding portion protrudes from an inner edge of the first slot into the first slot;
the second feeding portion extends from one end of the first feeding portion in a direction intersecting with the horizontal plane.

7. The multiband antenna as recited in claim 1, wherein:
the multiband antenna further comprises a radiation element;
the radiation element has a first part and a second part;
the first part extends from the first long edge so as to go away from the slot in the second direction;
the second part extends from the first part in the first direction;
the first part has a first length in the second direction;
the second part has a second length in the first direction; and
the second length is longer than the first length.

8. The multiband antenna as recited in claim 7, wherein the first part is nearer to the first slot than to the second slot.

9. The multiband antenna as recited in claim 8, wherein the first part is nearer to the opening portion than to a middle of the slot in the first direction at least in part.

10. The multiband antenna as recited in claim 7, wherein the radiation element is bent and thereby has a first radiation portion, which extends in the horizontal plane, and a second radiation portion, which extends from the first radiation portion in a direction intersecting with the horizontal plane.

11. The multiband antenna as recited in claim 1, wherein:
the multiband antenna further comprises a stub;
the conductor main portion has a connection portion and a facing portion;
the connection portion and the facing portion are arranged in the second direction to interpose the slot therebetween;
one end of the stub is connected to the connection portion; and
a remaining one end of the stub is apart from and faces the facing portion.

12. The multiband antenna as recited in claim 1, wherein the multiband antenna further has an extension portion extending from the conductor main portion in a direction intersecting with the horizontal plane.

13. The multiband antenna as recited in claim 12, wherein the multiband antenna further has an additional extension portion extending from the extension portion in a direction intersecting with the extension portion.
